(19) United States
(12) Patent Application Publication
(10) Pub. No.: US 2010/0058034 A1
(43) Pub. Date: Mar. 4, 2010

(54) CREATING REGISTER DEPENDENCIES TO MODEL HAZARDOUS MEMORY DEPENDENCIES

(75) Inventor: Ayal Zaks, D.N. Misgav (IL)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/201,445

(22) Filed: Aug. 29, 2008

(51) Int. Cl. G06F 9/30

(52) U.S. Cl. 712/216; 712/E09.027

(57) ABSTRACT

A method of transforming low-level programming language code written for execution by a target processor includes receiving data comprising a plurality of low-level programming language instructions ordered for sequential execution by the target processor; detecting a pair of instructions in the plurality of low-level programming language instructions having a memory dependency therebetween; and inserting one or more instructions between the detected pair of instructions in the plurality of low-level programming language instructions having a memory dependency therebetween. The one or more instructions inserted between the detected pair of instructions create a true data dependency on a value stored in an architectural register of the target processor between the detected pair of instructions.

### BACKGROUND

Exemplary embodiments of the present invention relate memory dependencies arising during execution of programming code, and more particularly, to avoiding hazards that can result from such dependencies.

Modern computer processors (or microprocessors) utilize various design techniques for enhancing the speed and overall performance of the processor. One such technique is speculative instruction execution, in which a branch prediction unit predicts the outcome of a branch instruction to allow the instruction fetch unit to fetch subsequent instructions according to the predicted outcome. These instructions are then “speculatively” processed and executed to allow the processor to make forward progress while the branch instruction is resolved. Another performance-enhancing technique is out-of-order instruction processing, in which instructions are processed in parallel in multiple pipelines independently.

In out-of-order processing, the instructions are not necessarily input into the pipelines in the same order that they were received by the processor. Additionally, because different instructions can take different amounts of time to execute, it is possible for a second instruction to be fully executed before a first instruction, even though the first instruction was input into its respective pipeline first. Accordingly, instructions are not necessarily executed in the same order in which they are received by the pipelines within out-of-order processors, and as a result, dependencies, which include register dependencies and memory dependencies, can arise from two instructions that access or modify the same resource. For instruction ordering to be semantically correct, if a second instruction has a dependency on a first instruction, then the dependent second instruction must be executed after the first instruction to ensure proper program operation.

A register dependency results when an instruction requires a register value that is not yet available from a previous instruction. Memory dependencies, which arise with memory instructions (that is, loads and store operations) where the location of operand is indirectly specified as a register operand rather than directly specified in the instruction encoding itself, can disrupt execution by out-of-order processors (such as IBM's PowerPC970 and Power5 processors), as these dependencies are not statically determinable. Out-of-order processors can execute instructions out-of-order mistakenly when memory dependencies are not recognized. For example, where a store instruction that writes a value to a memory location specified by a value in a first register precedes a load instruction that reads the value at a memory location specified by a value in a second register, the processor is unable to statically determine, prior to execution, whether the memory locations specified in these two instructions are different, as the memory locations depend on the values in the two registers. The instructions are independent and can be successfully executed out of order if the locations are different, but if the locations are the same, the load is dependent on the store to produce its value. Executing a dependent load/store pair out of order can produce incorrect results, which results in the processor rolling back execution and re-executing the rolled back instructions.

One attempt to solve processing conflicts that arise due to memory dependencies is to separate load instructions from store instructions by placing NOP (short for “no operation”) instructions or other instructions of the type that perform no computation or data manipulation that alters architectural state, and that require a specific number of clock cycles to execute, between them. This separation attempts to avoid hazards during execution by delaying the fetching of the load instruction a sufficient amount of time after fetching of the store instruction to prevent the processor from performing an early, speculative execution of the load instruction. The insertion of NOP instructions, however, in addition to increasing the code size, may not always be effective, as the number of NOP instructions that will be sufficient to avoid a hazard cannot always be determined. Another attempt to solve processing conflicts caused by memory dependencies is to insert memory barrier instructions between store and load instructions. A memory barrier is a class of hardware-dependent instructions that cause a processor to enforce an ordering constraint on memory operations issued before and after the barrier. Such memory barriers, however, can have the effect of delaying execution unnecessarily, as the barrier operates by ensuring that each and every load and store operation prior to the barrier will have been committed prior to any load and store operations issuing after the barrier.

### SUMMARY

An exemplary embodiment of a method of transforming low-level programming language code written for execution by a target processor includes receiving data comprising a plurality of low-level programming language instructions ordered for sequential execution by the target processor; detecting a pair of instructions in the plurality of low-level programming language instructions having a memory dependency therebetween; and inserting one or more instructions between the detected pair of instructions in the plurality of low-level programming language instructions having a memory dependency therebetween. The one or more instructions inserted between the detected pair of instructions create a true data dependency on a value stored in an architectural register of the target processor between the detected pair of instructions.

Exemplary embodiments of the present invention that are related to computer program products and data processing systems corresponding to the above-summarized method are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1 is a block diagram illustrating the functional elements of an exemplary embodiment of a processor that may benefit by the performance aspects provided by exemplary embodiments of the present invention.

FIG. 2 is a block diagram illustrating a compiler configured in accordance with an exemplary embodiment of the present invention is provided.

FIG. 3 is a flow diagram illustrating a process of artificially injecting true register dependencies between dependent store and load operations in a set of low-level programming code in accordance with an exemplary embodiment of the present invention.

FIG. 4 is a block diagram illustrating an exemplary computer system that can be used for implementing exemplary embodiments of the present invention.

The detailed description explains exemplary embodiments of the present invention, together with advantages and features, by way of example with reference to the drawings. The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

### DETAILED DESCRIPTION

While the specification concludes with claims defining the features of the invention that are regarded as novel, it is believed that the invention will be better understood from a consideration of the description of exemplary embodiments in conjunction with the drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form. Further, the terms and phrases used herein are not intended to be limiting but rather to provide an understandable description of the invention. As used herein, the singular forms “a”, “an”, and “the” are intended to include the plural forms as well, unless the content clearly indicates otherwise. It will be further understood that the terms “comprises”, “includes”, and “comprising”, when used in this specification, specify the presence of stated features, integers, steps, operations, elements, components, and/or groups thereof.

Exemplary embodiments of the present invention can be implemented to provide for a code transformation mechanism (for example, a compiling mechanism) for solving processing conflicts that arise during execution by out-of-order processors due to memory dependencies. More particularly, exemplary embodiments can be implemented to utilize the operative aspects of the dependency control mechanisms employed by out-of-order processors for preventing hazards due to true register dependencies to also avoid hazards caused by conflicts that arise during execution due to memory dependencies. The code transformation mechanisms implemented in exemplary embodiments, and described in greater detail below, operate by artificially injecting true register dependencies in program code between dependent store and load operations, which, during execution of the program code, will have the effect of causing the control mechanism employed by the executing processor for preventing hazards due to register dependencies to indirectly result in the processor postponing issue of a first memory operation (that is, a load or a store) until any other memory operations in the code being executed upon which the first memory operation is dependent are ready to execute. Exemplary embodiments can thereby be implemented to serialize the execution of dependent memory operations in a manner that prevents costly erroneous speculation and improves the performance of out-of-order processors.

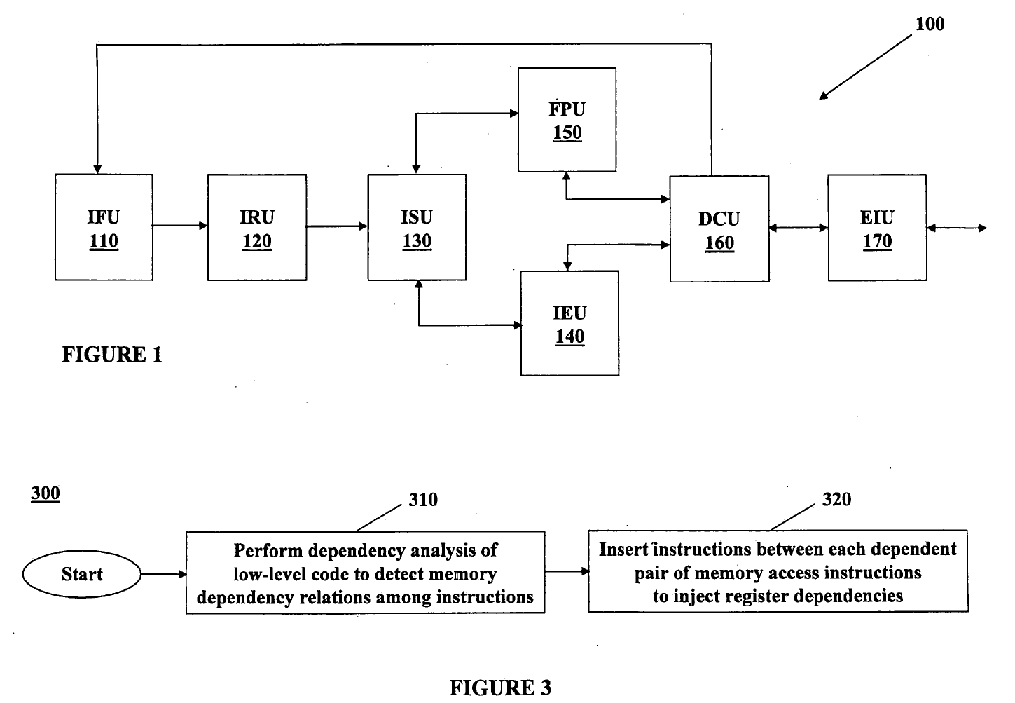

Referring now to FIG. 1, an exemplary embodiment of an out-of-order processor 100 is illustrated. Exemplary processor 100 is represented as a collection of interacting functional elements in FIG. 1 using a block diagram. The functional units are identified using a precise nomenclature for ease of description and understanding, but other nomenclature is often used to identify equivalent functional units. These functional units, discussed in greater detail below, perform the functions of fetching instructions and data from memory, preprocessing fetched instructions, scheduling instructions to be executed, executing the instructions, managing memory transactions, and interfacing with external circuitry and devices. It is expressly noted, however, that the inventive features of the present invention may be usefully employed in various exemplary embodiments for a number of alternative processor architectures that can benefit from the performance aspects provided by the present invention. For example, it is contemplated that processor 100 may be implemented with more or fewer functional components and still benefit from the performance aspects provided by the present invention.

It should be understood that the elements of processor 100 are not the theme of the present invention, and that exemplary embodiments of the present invention are more generally applicable to any processor or processing system in which it is desirable to solve processing conflicts that arise during execution due to memory dependencies. The term “processor” as used herein is thus intended to include any device in which instructions retrieved from a memory or other storage element are executed using one or more execution units. Exemplary processors in accordance with the present description may therefore include, for example, microprocessors, central processing units (CPUs), very long instruction word (VLIW) processors, single-issue processors, multi-issue processors, digital signal processors, application-specific integrated circuits (ASICs), personal computers, mainframe computers, network computers, workstations and servers, and other types of data processing devices, as well as portions and combinations of these and other devices.

Referring to exemplary processor 100 illustrated in FIG. 1, an instruction fetch unit (IFU) 110 comprises instruction fetch mechanisms and includes, among other things, an instruction cache for storing instructions, branch prediction logic, and address logic for addressing selected instructions in the instruction cache. The instruction cache is commonly referred to as a portion of the level one (L1) cache, which also includes another portion dedicated to data storage. IFU 110 fetches one or multiple instructions each cycle by appropriately addressing the instruction cache. The instruction cache feeds addressed instructions to an instruction rename unit (IRU) 120.

In the absence of conditional branch instruction, IFU 110 addresses the instruction cache sequentially. The branch prediction logic in IFU 110 handles branch instructions, including unconditional branches. More than one branch can be predicted simultaneously by supplying sufficient branch prediction resources. After the branches are predicted, the address of the predicted branch is applied to the instruction cache rather than the next sequential address. If a branch is mispredicted, the instructions processed following the mispredicted branch are flushed from processor 100, and the process state is restored to the state prior to the mispredicted branch.

IRU 120 comprises one or more pipeline stages that include instruction renaming and dependency control mechanisms. The instruction renaming mechanism is operative to map register specifiers in the instructions to physical register locations and to perform register renaming to prevent dependencies. IRU 120 further comprises dependency control mechanisms, described below, that analyze the instructions to determine if the operands (identified by the instructions' register specifiers) cannot be determined until another “live instruction” has completed. The term “live instruction” as used herein refers to any instruction that has been fetched from the instruction cache, but has not yet completed or been retired.

Because instructions are not necessarily executed in the same order in which they are received by the functional elements within processor 100, IRU 120 implements dependency control mechanisms to prevent errors that may otherwise arise from hazards caused by register dependencies, as is typical employed within an out-of-order processor. More specifically, the control mechanisms are implemented to ensure that an instruction to store a value in a register and an instruction to refer to the stored value are not issued in the same cycle according to the information on the names of registers to which is referred to for the data and in which the data is stored. For example, the control mechanisms may be configured to, during the execution of each instruction by the processor, determine whether a live instruction requires data produced by the execution of an older instruction (that is, whether a “true” register dependency is present). If so, the control mechanisms then determine whether the older instruction has been processed, at least to the point where the needed data is available. If this data is not yet available, the control mechanisms operate to stall (that is, temporarily stop) processing of the pending instruction until the necessary data becomes available, thereby preventing errors from read-after-write (RAW) data hazards.

Each pending instruction will have up to three register specifiers or fields, a first source register (rs1), a second source register (rs2), and a destination register (rd). To determine dependencies of a pending instruction in the bundle, the dependency control mechanisms of IRU 120 can compare the source registers of the instruction to the destination registers of prior or older live instructions maintained in a dependency table. To prevent errors from RAW data hazards, stalling of the pending instruction can be accomplished by asserting a stall signal transmitted to the functional elements of processor 100 executing the pending instruction. In response to the asserted stall signal, the functional elements are designed to stop execution of the pending instruction until the stall signal is deasserted by the control mechanisms. Once the data hazard no longer exists, the control mechanisms de-assert the stall signal, and in response, processor 100 resumes processing of the pending instruction.

IRU 120 outputs renamed instructions to an instruction scheduling unit (ISU) 130, and indicates any dependency which the instruction may have on other prior or older live instructions. ISU 130 receives renamed instructions from IRU 120 and registers them for execution. ISU 130 is operative to schedule and dispatch instructions as soon as their dependencies have been satisfied into an appropriate execution unit (for example, by an integer execution unit (IEU) 140 or a floating-point unit (FPU) 150). ISU 130 also maintains trap status of live instructions. ISU 130 may perform other functions such as maintaining the correct architectural state of processor 100, including state maintenance when out-of-order instruction processing is used. ISU 130 may include mechanisms to redirect execution appropriately when traps or interrupts occur and to ensure efficient execution of multiple threads where multiple threaded operation is used. Multiple thread operation means that processor 100 is running multiple substantially independent processes simultaneously. Multiple thread operation is consistent with but not required to benefit from the performance aspects provided by the present invention.

ISU 130 also operates to retire executed instructions when completed by IEU 140 and FPU 150. ISU 130 performs the appropriate updates to architectural register files and condition code registers upon complete execution of an instruction. ISU 130 is responsive to exception conditions and discards or flushes operations being performed on instructions subsequent to an instruction generating an exception in the program order. ISU 130 quickly removes instructions from a mispredicted branch and initiates IFU 110 to fetch from the correct branch. An instruction is retired when it has finished execution and all instructions from which it depends have completed. Upon retirement the instruction's result is written into the appropriate register file and is no longer deemed a “live instruction.”

IEU 140 includes one or more pipelines, each pipeline comprising one or more stages that implement integer instructions. IEU 140 also includes mechanisms for holding the results and state of speculatively executed integer instructions. IEU 140 functions to perform final decoding of integer instructions before they are executed on the execution units and to determine operand bypassing amongst instructions in an out-of-order processor. IEU 140 executes all integer instructions including determining correct virtual addresses for load/store instructions. IEU 140 also maintains correct architectural register state for a plurality of integer registers in processor 100. IEU 140 can include mechanisms to access single and/or double-precision architectural registers as well as single and/or double-precision rename registers.

FPU 150 includes one or more pipelines each comprising one or more stages that implement floating-point instructions. FPU 150 also includes mechanisms for holding the results and state of speculatively executed floating-point instructions. FPU 150 functions to perform final decoding of floating-point instructions before they are executed on the execution units and to determine operand bypassing amongst instructions in an out-of-order processor. FPU 150 can include mechanisms to access single and/or double-precision architectural registers as well as single and/or double-precision rename registers.

A data cache memory unit (DCU) 160, including a cache memory, functions to cache memory reads from off-chip memory through external interface unit (EIU) 170. Optionally, DCU 160 also caches memory write transactions. DCU 160 comprises one or more hierarchical levels of cache memory and the associated logic to control the cache memory. One or more of the cache levels within DCU 160 may be read only memory to eliminate the logic associated with cache writes.

Exemplary embodiments of the code transformation mechanism as presented herein are described as being implemented within a compiler, which is software for translating a source program described in a high-level language to an object program to be run on a target processor or computer. Nevertheless, it should be noted that, in other exemplary embodiments, the code transformation mechanism can be implemented for incorporation with or within any suitable pre-processing instruction organizing applications and techniques, such as, for example, just-in-time compilation (JIT), interpreters, and assemblers. In yet other exemplary embodiments, the code transformation mechanism can be implemented for direct application to object code following compilation and prior to assembling the object code, or for direct application to machine code following assembling.

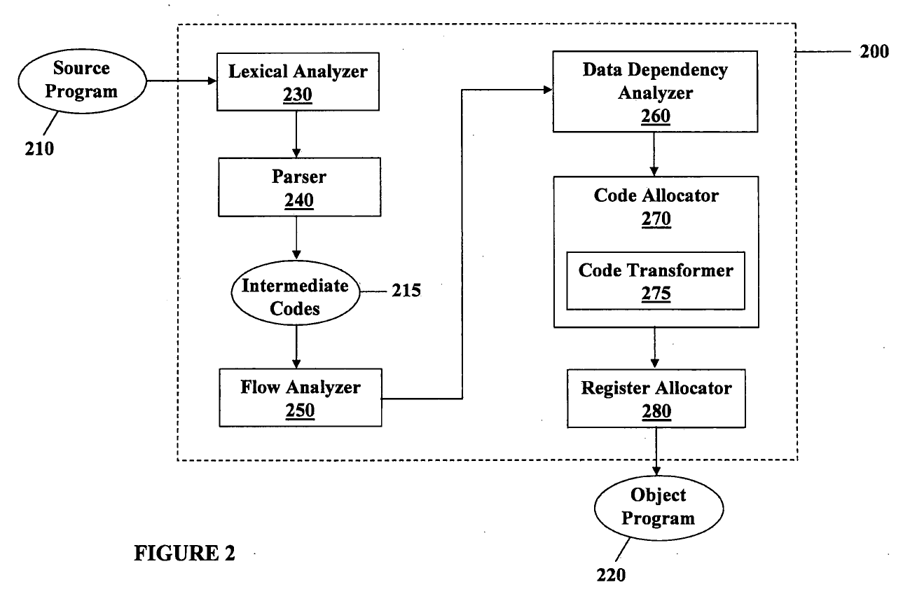

Referring now to FIG. 2, a block diagram illustrating a compiler 200 configured in accordance with an exemplary embodiment of the present invention is provided. Compiler 200 generally includes a lexical analyzer component 230, a parser component 240, a flow analyzer component 250, a data dependency analyzer component 260, a code allocator component 270, and a register allocator component 280. As shown in FIG. 2, compiler 200 generally operates by receiving as input a source program 210 described in a high-level programming language such as, for example, C++, FORTRAN, or PASCAL, performing allocation of instructions, and generating an object program 220 in a lower-level language such as assembly language or machine language that is executable by a target processor or computer to perform instructions specified by the source program. Source program 210 can be received from one or more text files stored, for example, on main memory or a storage device such as a disk.

In exemplary embodiments, compiler 200 can be implemented in software. In these embodiments, components 230, 240, 250, 260, 270, and 280 may be implemented as program modules. As used herein, the term “program modules” includes routines, programs, objects, components, data structures, and instructions, or instructions sets, and so forth that perform particular tasks or implement particular abstract data types. As can be appreciated, the modules can be implemented as software, hardware, firmware and/or other suitable components that provide the described functionality, which may be loaded into memory of the machine embodying exemplary embodiments of a code transformation mechanism in accordance with the present invention. Aspects of the modules may be written in a variety of programming languages, such as C, C++, Java, etc. The functionality provided by the modules described with reference to exemplary embodiments described herein can be combined and/or further partitioned.

Lexical analyzer 230 is configured to analyze a stream of characters that constitutes the input source program and break the character stream text into tokens. Each token is single atomic unit of the source program language such as a keyword, identifier, or symbol name. Parser 240 is configured to assess the tokens resulting from the lexical analysis to identify the syntactic structure of source program 210 and, in the event of a syntax error, stop the execution with notification. If the tokens obey the rules of the syntax of the high-level language, then parser 240 generates intermediate codes 215 from the results of the parsing. The resulting intermediate codes can be stored into main memory or a storage device such as a disk. Intermediate codes 215 can be managed inside the compiler.

Flow analyzer 250 is configured to, upon generation of intermediate codes 215, analyze the flow of the program on the basis of the intermediate codes. Data dependency analyzer 260 is configured to, following analysis of the program flow, perform a data dependency analysis of each of the element parts constituting intermediate codes 215 to determine constraints on what order the instruction allocation must be performed. In one particular aspect, data dependency analyzer 260 is configured to identify memory dependencies between instructions in intermediate code 215. Code allocator 270 produces codes (the object program equivalent allocated pseudo resisters) just short of the object program on the basis of intermediate codes 215. In the present exemplary embodiment, code allocator includes a code transformer 275 for artificially injecting true register dependencies in the codes produced on the basis of intermediate codes 215 between dependent store and load operations (as identified by data dependency analyzer 260), which, during execution of object program 220, will have the effect of causing the control mechanism employed by the executing processor for preventing hazards due to true register dependencies to direct the processor to postpone issuing a first memory operation (that is, a load or a store) until any other memory operations in the code being executed upon which the first memory operation is dependent are ready to execute. Register allocator 280 is configured to perform such register allocation that real registers of the target processor are reallocated to the codes that have been generated by code allocator 270 with provisionally allocated pseudo registers, thereby completing generation of object program 220. Object program 220 can then, for example, be stored into main memory or a storage device such as a disk. Where object program 220 is written in assembly language, the assembly language code can be converted by an assembler into machine language code that is intended for execution by the target processor. To execute object program 220, the target processor can, for example, load the object program code into RAM and then read and execute the code.

It should be noted that, are used herein, the terms load, load instruction, and load operation instruction are used interchangeably to refer to instructions which cause data to be loaded, or read, from memory. This includes typical load instructions, as well as move, compare, add, and the like where these instructions require the reading of data from memory or cache. Similarly, are used herein, the terms store, store instruction, and store operation instruction are used interchangeably to refer to instructions which cause data to be written to memory or cache.

Referring now to FIG. 3, a flow diagram illustrating a process 300 of artificially injecting true register dependencies between dependent store and load operations in a set of low-level programming code (that is, code specified in a language having a small or nonexistent amount of abstraction between itself and the machine language of the target processor or that is not written a high-level programming language that would require a compiler or an interpreter to run) in accordance with an exemplary embodiment of the present invention is provided. The artificial register dependencies are injected in exemplary process 300 to cause the dependency control mechanisms employed by an out-of-order processor for preventing hazards due to register dependencies (for example, the control mechanisms implemented by IRU 120 of exemplary processor 100 described above with reference to FIG. 1) to direct the processor, during execution, to postpone issuing a first memory operation (that is, a load or a store) until any other memory operations in the code being executed upon which the first memory operation is dependent are ready to execute. Exemplary process 300 may be performed, for example, by code transformer 275 of exemplary compiler 200 described above with reference to FIG. 2.

In exemplary process 300, at block 310, dependency analysis of the low-level programming code set is performed to detect memory dependency relations among the instructions in the code set. Memory dependencies occur with memory access instructions (that is, load and store operations) where the location of operand is indirectly specified as a register operand rather than directly specified in the instruction encoding itself. There are three particular types of memory dependencies identified at block 310: (1) Read-After-Write (RAW) dependencies, which arise when a load operation reads a value from memory that was produced by the most recent preceding store operation to that same address; (2) Write-After-Read (WAR) dependencies, which arise when a store operation writes a value to memory that a preceding load reads; and Write-After-Write (WAW) dependencies, which arise when two store operations write values to the same memory address. Each type of memory dependency poses a hazard during execution by an out-of-order processor. RAW dependencies may cause the load operation to read incorrect data because the store operation may not have finished writing to the address, WAR dependencies may cause the load operation to incorrectly read the new written value because the store operation may have finished before the load, and WAW dependencies may leave the memory address with the incorrect data value because the first store operation issued may finish after the second. The memory dependency detection performed at block 310 can be performed, for example, within exemplary compiler 200, described above with reference to FIG. 2, by data dependency analyzer 260.

The following example of code written in pseudo-C statements for performing a long-to-double conversion provides an example of an RAW dependency:

Double fo 1 (long f)
{
return (double) f;
}

When compiled, the conversion code statements will produce object code directing data from general-purpose registers to be stored to memory and then loaded from memory to a floating-point register, as shown in the following sample pseudo-assembly language code statements:

stw 0, 12(1) //store 4 bytes of GPR0 into address GPR1+12

stw 9, 8(1) //store 4 bytes of GPR9 into address GPR1+8

lfd 0, 8(1) //load 8 bytes from address GPR1+8 into FPR0

In the above assembly language code, the ‘lfd 0, 8(1)’ load operation has an RAW dependence on the preceding ‘stw 9, 8(1)’ store operation because the load operation reads from the memory address that the preceding store operation wrote. The ‘lfd 0, 8(1)’ load operation also has an RAW dependence on the preceding ‘stw 0, 12(1)’ store operation.

At block 320 in exemplary process 300, for each memory dependency relation among the instructions in the code set detected at block 310 (or at least for each memory dependency relation among the instructions in the code set detected at block 310 determined to present a risk of speculative execution), code statements are inserted into the code set between the dependent memory access instructions to artificially inject a true register dependency. The artificial register dependencies are injected in exemplary process 300 to cause the dependency control mechanisms employed by an out-of-order processor for preventing hazards due to register dependencies (for example, the control mechanisms implemented by IRU 120 of exemplary processor 100 described above with reference to FIG. 1) to direct the processor, during execution, to postpone issuing a first memory operation (that is, a load or a store) until any other memory operations in the code being executed upon which the first memory operation is dependent are ready to execute. That is, the code statements inserted at block 320 operate to indirectly inform the processor of exact dependencies between memory access instructions, and can be particularly coded to not cause incorrect execution, for example, by effecting a change in the state of any programmer accessible registers, status flags, or memory. In exemplary embodiments, the code statements inserted at block 320 can further include a ‘nop’ (no operation) instruction after each set of code statements injecting artificial register dependencies to further ensure that memory alignment is enforced.

For example, the above assembly language code example can be modified at block 320 as shown below to utilize the dependency control mechanisms for preventing hazards due to register dependencies employed by out-of-order processors to solve the processing conflict caused by the RAW dependency of the long-to-double conversion by causing the processor to not issue the load operation until after the value in GPR9 (which is the value that should be stored in FPR0) is available:

stw 0, 12(1) //store 4 bytes of GPR0 into address GPR1+12

stw 9, 8(1) //store 4 bytes of GPR9 into address GPR1+8

sub 0, 9, 9 //GPR0=GPR9−GPR9(=0)

add 1, 1, 0 //GPR1=GPR1+GPR0(=GPR1)

lfd 0, 8(1) //load 8 bytes from address GPR1+8 into FPR0

During execution of the above modified code, the dependency control mechanisms employed by the processor will operate to ensure that the ‘lfd 0, 8(1)’ instruction cannot be executed until the result of execution of the ‘add 1, 1, 0’ instruction is available. Because GRP0 is the destination register of the ‘sub 0, 9, 9’ instruction, the execution of the ‘add 1, 1, 0’ instruction depends on the outcome of the ‘sub 0, 9, 9’ instruction (that is, there is a true register dependency between these two instructions) and cannot occur until the results of the ‘sub 0, 9, 9’ instruction are known. Also, because GRP1 is the destination register of the ‘add 1, 1, 0’ instruction, the execution of the ‘lfd 0, 8(1)’ instruction depends on the outcome of the ‘add 1, 1, 0’ instruction and cannot occur until the results of the ‘add 1, 1, 0’ instruction are known. Thus, the RAW memory dependency between the ‘lfd 0, 8(1)’ load operation and the preceding ‘stw 9, 8(1)’ store operation is resolved because the dependency control mechanism employed by the processor, by stalling issuance of the ‘lfd 0, 8(1)’ instruction as described, will indirectly ensure that the load operation will read the same value that will be written to the memory address upon completion of the execution of the store operation. That is, as a result of the response by the dependency control mechanisms to the register dependencies described above, issuance of the load operation will be stalled until the data needed for the store operation to properly execute (which includes both the value to be stored in GPR9 and the address at which to store to be stored in GPR1). Additionally, the inserted instructions will not cause incorrect execution, for example, by effecting a change in the state of any programmer accessible registers, status flags, or memory.

Of course, it should be noted that the instructions inserted into the above assembly language code example are non-limiting and provided for exemplary purposes only. That is, based on the description herein, it should be appreciated that, in exemplary embodiments, any of a variety of suitable low-level programming instructions, as defined by the instruction set architecture of a target processor (for example, RSIC, VLIW, SIMD, etc.), may be inserted into object code to artificially inject true register dependencies between dependent memory access instructions, and, furthermore, any of a variety of suitable techniques can be utilized in exemplary embodiments for choosing these instructions. In addition to arithmetic instructions such as add and subtract operations, the inserted instructions may include, for example, logic instructions such as and, or, and not operations, data instructions such as move, input, output, load, and store operations, and/or other suitable instructions.

In the preceding description, for purposes of explanation, numerous specific details are set forth in order to provide a thorough understanding of the described exemplary embodiments. Nevertheless, one skilled in the art will appreciate that many other embodiments may be practiced without these specific details and structural, logical, and electrical changes may be made.

Some portions of the exemplary embodiments described above are presented in terms of algorithms and symbolic representations of operations on data bits within a processor-based system. The operations are those requiring physical manipulations of physical quantities. These quantities may take the form of electrical, magnetic, optical, or other physical signals capable of being stored, transferred, combined, compared, and otherwise manipulated, and are referred to, principally for reasons of common usage, as bits, values, elements, symbols, characters, terms, numbers, or the like. Nevertheless, it should be noted that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

Exemplary embodiments of the present invention can be realized in hardware, software, or a combination of hardware and software. Exemplary embodiments can be implemented using one or more program modules and data storage units. Exemplary embodiments can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Exemplary embodiments of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system in which exemplary embodiments can be implemented may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface including a wired network or a wireless network that allow a computer system to read such computer readable information.

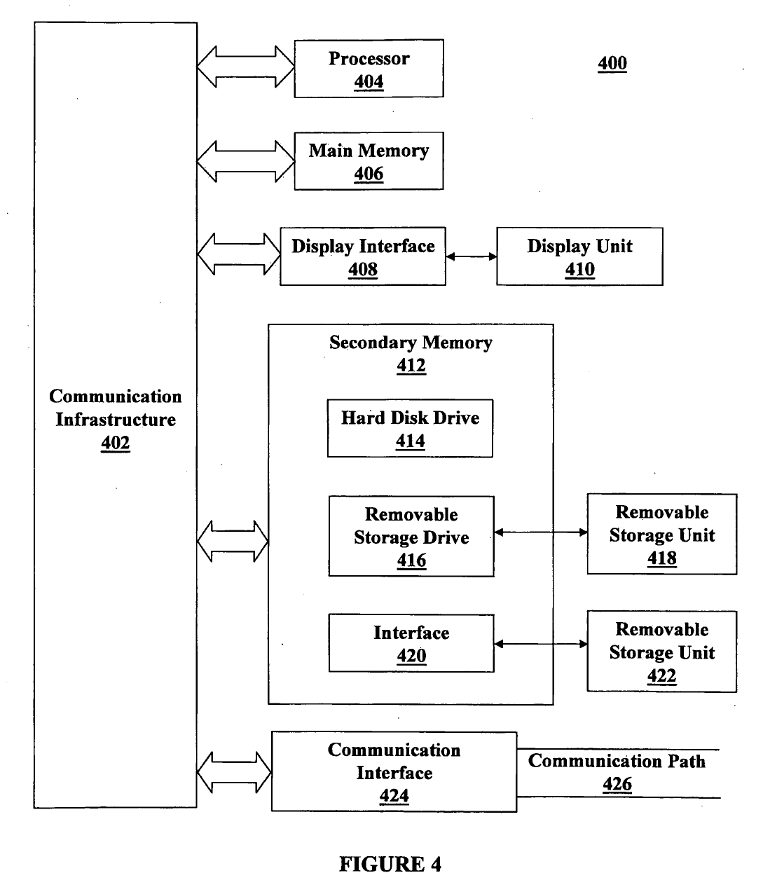

FIG. 4 is a block diagram of an exemplary computer system 400 that can be used for implementing exemplary embodiments of the present invention. Computer system 400 includes one or more processors, such as processor 404. Processor 404 is connected to a communication infrastructure 402 (for example, a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

Exemplary computer system 400 can include a display interface 408 that forwards graphics, text, and other data from the communication infrastructure 402 (or from a frame buffer not shown) for display on a display unit 410. Computer system 400 also includes a main memory 406, which can be random access memory (RAM), and may also include a secondary memory 412. Secondary memory 412 may include, for example, a hard disk drive 414 and/or a removable storage drive 416, representing a floppy disk drive, a magnetic tape drive, an optical disk drive, etc. Removable storage drive 416 reads from and/or writes to a removable storage unit 418 in a manner well known to those having ordinary skill in the art. Removable storage unit 418, represents, for example, a floppy disk, magnetic tape, optical disk, etc. which is read by and written to by removable storage drive 416. As will be appreciated, removable storage unit 418 includes a computer usable storage medium having stored therein computer software and/or data.

In exemplary embodiments, secondary memory 412 may include other similar means for allowing computer programs or other instructions to be loaded into the computer system. Such means may include, for example, a removable storage unit 422 and an interface 420. Examples of such may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between the computer system and external devices. Examples of communications interface 424 may include a modem, a network interface (such as an Ethernet card), a communications port, a PCMCIA slot and card, etc. Software and data transferred via communications interface 424 are in the form of signals which may be, for example, electronic, electromagnetic, optical, or other signals capable of being received by communications interface 424. These signals are provided to communications interface 424 via a communications path (that is, channel) 426. Channel 426 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 406 and secondary memory 412, removable storage drive 416, a hard disk installed in hard disk drive 414, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface including a wired network or a wireless network that allow a computer to read such computer readable information.

Computer programs (also called computer control logic) are stored in main memory 406 and/or secondary memory 412. Computer programs may also be received via communications interface 424. Such computer programs, when executed, can enable the computer system to perform the features of exemplary embodiments of the present invention as discussed herein. In particular, the computer programs, when executed, enable processor 404 to perform the features of computer system 400. Accordingly, such computer programs represent controllers of the computer system.

Although exemplary embodiments of the present invention have been described in detail, the present description is not intended to be exhaustive or limiting of the invention to the described embodiments. It should be understood that various changes, substitutions and alterations could be made thereto without departing from spirit and scope of the inventions as defined by the appended claims. Variations described for exemplary embodiments of the present invention can be realized in any combination desirable for each particular application. Thus particular limitations, and/or embodiment enhancements described herein, which may have particular advantages to a particular application, need not be used for all applications. Also, not all limitations need be implemented in methods, systems, and/or apparatuses including one or more concepts described with relation to exemplary embodiments of the present invention.

The exemplary embodiments presented herein were chosen and described to best explain the principles of the present invention and the practical application, and to enable others of ordinary skill in the art to understand the invention. It will be understood that those skilled in the art, both now and in the future, may make various modifications to the exemplary embodiments described herein without departing from the spirit and the scope of the present invention as set forth in the following claims. These following claims should be construed to maintain the proper protection for the present invention.

1. A method of transforming low-level programming language code written for execution by a target processor, the method comprising:
receiving data comprising a plurality of low-level programming language instructions ordered for sequential execution by the target processor;
detecting a pair of instructions in the plurality of low-level programming language instructions having a memory dependency therebetween; and
inserting one or more instructions between the detected pair of instructions in the plurality of low-level programming language instructions having a memory dependency therebetween, the one or more instructions inserted between the detected pair of instructions creating a true data dependency on a value stored in an architectural register of the target processor between the detected pair of instructions.

2. The method of claim 1, further comprising inserting a no operation instruction in the plurality of low-level programming language instructions for the detected pair of instructions having a memory dependency therebetween, the no operation instruction for the detected pair of instructions being inserted immediately sequentially following the one or more instructions inserted between the detected pair of instructions.

3. The method of claim 1, wherein the target processor is an out-of-order processor employing a control mechanism configured to direct the target processor to postpone issue of a first live instruction referring to data stored in a first architectural register of the target processor until data to be stored in the first architectural register upon issue of a second live instruction is available to the target processor where the second live instruction is ordered to be executed prior to the first live instruction.

4. The method of claim 1, wherein the method is performed by a pre-processing instruction organizing application selected from compilers, interpreters, assemblers, and combinations thereof.

5. The method of claim 1, wherein the plurality of low-level programming instructions are written in assembly language code or machine language code that is executable by the target processor.
